(19) United States
(12) Patent Application Publication
(10) Pub. No.: US 2022/0047899 A1
(43) Pub. Date: Feb. 17, 2022

(54) PARTICLE RETAINER DEVICE AND METHOD

(71) Applicant: Kevin Woner, Tucson, AZ (US)

(72) Inventor: Kevin Woner, Tucson, AZ (US)

(21) Appl. No.: 17/482,299

(22) Filed: Sep. 22, 2021

Related U.S. Application Data
(63) Continuation-in-part of application No. 15/686,062, filed on Aug. 24, 2017, now abandoned.
(60) Provisional application No. 62/404,212, filed on Oct. 5, 2016.

(51) Int. Cl. A62B 18/02; A62B 23/02; A41D 13/11

(52) U.S. Cl. CPC A62B 18/025; A41D 13/1138; A41D 13/1161; A62B 23/02

(57) ABSTRACT

A particle retainer having a support frame including at least one air flow port configured to permit contaminated ambient air to reach the filtration element of the particulate matter filtration mask. The particle retainer also has a mask mount fixed to the support frame configured to removably attach the particle retainer to the mask. The particle retainer further includes an air flow port cover affixed to the support frame, in which the air flow port cover features manually operable open state and closed state configurations for permitting and restricting air flow and particulate matter transfer.

### CROSS-REFERENCE TO RELATED APPLICATION(S)

The present application is related to and claims priority to U.S. Non-provisional patent application Ser. No. 15/686,062, filed on Aug. 24, 2017, is related to and claims priority to U.S. Provisional Patent Application No. 62/404,212 filed Oct. 5, 2016, both of which are incorporated by reference.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of respirators of existing art and more specifically relates to particulate matter filter devices.

### RELATED ART

Half-face respirators are sometimes worn by those working in hazardous environments, including but not limited to, areas affected by lead-based paint and asbestos. Particulate matter filters may often be attached to the respirators and re-used many times. The filters may be removed and then stored in a plastic bag, toolbox, or other container. The respirator can be cleaned with soap and water. Often, the filters can remain attached to the respirator and then stored. In those cases, the filters themselves are not cleaned and contain hazardous particles that can be easily dislodged. These loose particles may then contaminate a surface or storage area, creating a means of exposure to unprotected individuals. A suitable solution is desired.

U.S. Pat. No. 7,101,412 to Otto Gossweiler relates to a self-sealing protection filter port. The described self-sealing protection filter port includes a self-sealing protection filter port for gas masks prevents contamination of the inner-environment of the mask during exchange of filters and therefore increases safety. A biased valve closes the air inlet to the port when the protection filter is not installed. As a new filter is inserted, the valve is forced open, allowing filtered air to flow through the air inlet to the user. The protection filter engages the filter port using a retaining element. The self-sealing protection filter in a protection mask having an internal close-biased valve is installed in the standard protection filter port of the mask.

### SUMMARY OF THE INVENTION

In view of the foregoing disadvantages inherent in the known respirator art, the present disclosure provides a novel particle retainer device and method. The general purpose of the present disclosure, which will be described subsequently in greater detail, is to provide a open and closable cover for containing hazardous particles that may become dislodged from a respirator filter.

The disclosed particle retainer for those filtration masks having a body, an air filtration element, and a respirator input disposed between the body and the filtration element has a fixed support frame having ribs extending radially from an axle mount ending at the edge of a retaining ring that extends perpendicularly away from the perimeter of the support frame toward the mask body and having fixed air-flow ports disposed between the ribs. In some cases, the ribs block airflow into the respirator input, the fixed air-flow ports allow airflow into the respirator input, and the retaining ring engages the respirator input. The device has a rotatable cover having radial leaves divided by passages and an axle that mounts in the axle mount and is rotatable around the axle between an open and a closed position. In the open position, as a user inhales ambient air enters into the respirator input through the fixed air-flow ports and the passages. This process collects hazardous particulates in the filter medium.

In the closed position, the leaves seal the fixed air-flow ports and prevent that hazardous particulate matter from exiting or falling out of the mask.

In some cases, the retaining ring engages the respirator input through an airtight seal and sometime the retaining ring snaps into place on the respirator input. In some versions, the fixed support frame has a first color and the radial leaves are a second color. Sometimes the first color contrasts with the second color, which can indicate from a distance the open or closed position of the rotatable cover. For instance, the relative amount of visible first color versus visible second color visually indicates whether the rotatable cover is open or closed. The cover is designed to need some type of manipulation to rotate it. It doesn't rotate on its own

Various methods of using such a cover for such a mask are also disclosed.

### BRIEF DESCRIPTION OF THE DRAWINGS

FIG. 1 is a perspective view of the particle retainer in the open position during an ‘in-use’ condition, according to an embodiment of the disclosure.

FIG. 2 is a perspective view of the particle retainer in the closed position of FIG. 1 mounted to a particulate matter filtration mask, according to an embodiment of the present disclosure.

FIG. 3 is a top view of the particle retainer of FIG. 1 alongside a filtration element, according to an embodiment of the present disclosure.

FIG. 4 is a bottom perspective view of the particle retainer of FIG. 1, according to an embodiment of the present disclosure.

FIG. 5 is a flow diagram illustrating a method of use for the respiration system, according to an embodiment of the present disclosure.

### DETAILED DESCRIPTION

As discussed above, embodiments of the present disclosure relate to respirators and more particularly to a particle retainer device as used to provide a open and closable cover for containing hazardous particles that may become dislodged from a respirator filter. The open and closable cover can be removable or attached as in integral component of a respirator cartridge.

Generally, the present invention provides particulate matter filters with a particle containment system that will prevent hazardous materials from escaping the filter. This eliminates the worry of asbestos, lead-based paint, and other materials from cross-contaminating storage or surface areas when the filter cartridges are not in use. It may utilize a hand-rotatable cover that can contain the filtered particulate matter inside the filter. According to one preferred embodiment, it may be configured to install onto existing PM100 particulate matter type filters, commonly used in conjunction with half-face respirators. This may allow filters and masks to be reused without worry of cross-contamination. The present disclosure advantageously requires minimal training to use the device efficiently.

During the manufacture and remediation of hazardous materials, including asbestos and lead-based paint, particles are often released into the air. Workers in these processes are required by OSHA to wear a respirator equipped with a particulate matter filter to protect the workers from the inhalation of hazardous materials. Many times, containment structures and controlled entry enclosed areas are constructed to prevent the release of hazardous particles into the air outside of the containment or enclosed area. A use of the disclosed particle retainer device is to contain the filtered hazardous particulate matter inside the filter, preventing secondary contamination, for example, in storage containers and on surface areas outside of a containment or enclosed area. A hand rotatable cover installed on the dirty side of the filter may lock the filtered particulate matter inside the particle lock device/particle retainer enclosure.

Currently, following the use of filters attached to half-face respirators used in hazardous materials environments, the filters, which are typically re-used many times, are removed from the half-face respirator then stored inside a plastic bag, toolbox or other suitable container. Sometimes the filters remain attached to the half-face respirator and are stored in a plastic bag or other container. The half-face respirator with filters removed can be cleaned with soap and water and reused over and over. The filters themselves are not cleaned and have no specific storage requirements. The dirty side of the filter collects hazardous particles that can be easily dislodged from the filter media leading to contamination on surfaces outside of a containment area or hazardous materials work area. Particles do fall out of the dirty side of the filter media. These hazardous particles should be contained to prevent hazardous material exposure to unprotected workers and family members.
10 filtration mask
11 filtration mask body
20 air filtration element
40 user
100 particle retainer
101 respirator system
110 ribs
109 edge
111 support frame
112 retaining ring
114 cover base
115 air flow port
120 mask mount
129 leaves
130 air flow port cover or rotatable cover
131 open state
132 closed state
133 support post or axle mount
135 air filtration element cover

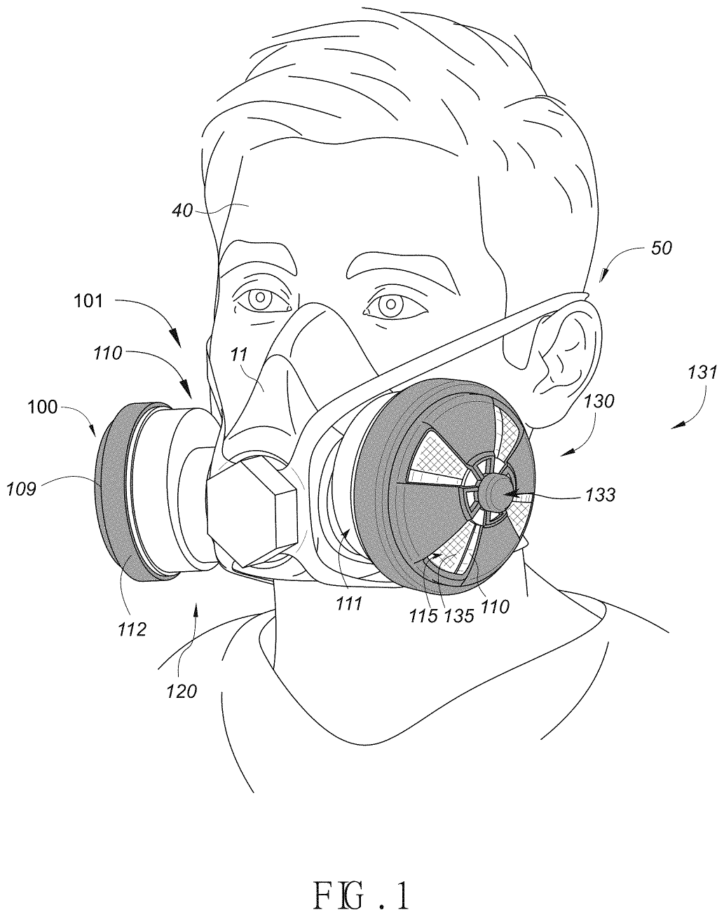

Referring now more specifically to the drawings by numerals of reference, there is shown in FIGS. 1-4, various views of a particle retainer 100.

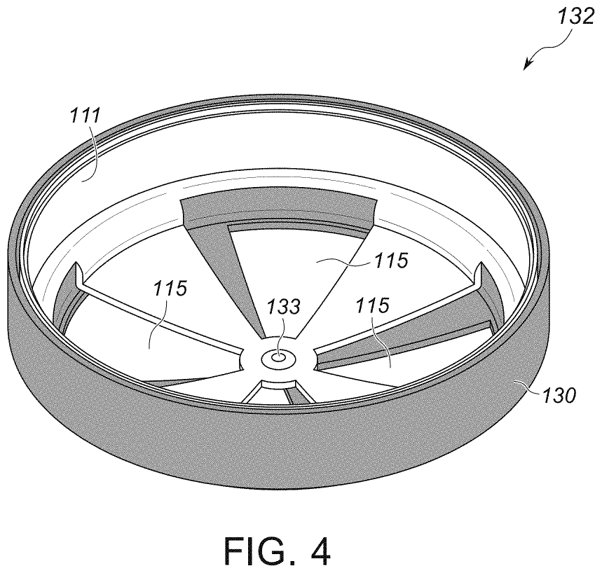

FIG. 1 shows a particle retainer in the open position 100 during an ‘in-use’ condition, according to an embodiment of the present disclosure. Here, the particle retainer 100 may be beneficial for use by a user 40 to provide an air flow port cover 130, an open and closable, removable or permanently attached as an integral component of a respirator cartridge. The air flow port cover 130 covers and contains hazardous particles that may become dislodged from a respirator filter. As illustrated, the particle retainer 100 may include a support frame 110 with a mask mount 120 (FIG. 4) and an air flow port cover 130 affixed to the support frame 110.

The present illustration additionally shows a respiration system 101 including a particulate matter filtration mask 10, at least one air filtration element 20 affixed to the particulate matter filtration mask 10, and the particle retainer 100 including the support frame 110, the mask mount 120, and the air flow port cover 130, an open and closable cover that can be removable or attached as an integral component of a respirator cartridge.

The support frame 111 may itself include at least one air flow port 115 cut from/integrated with the support frame 110, or otherwise configured to permit the contaminated ambient air to reach the at least one air filtration element 20 while coupled to the particulate matter filtration mask 10 and in an open state 131. Support frame 111 is a fixed support frame and has ribs 110 extending radially from an axle mount 133 ending at the edge 109 of a retaining ring 112 that extends perpendicularly away from the perimeter of support frame 110 toward the mask body 11 and having fixed air-flow ports 115 disposed between the ribs 110.

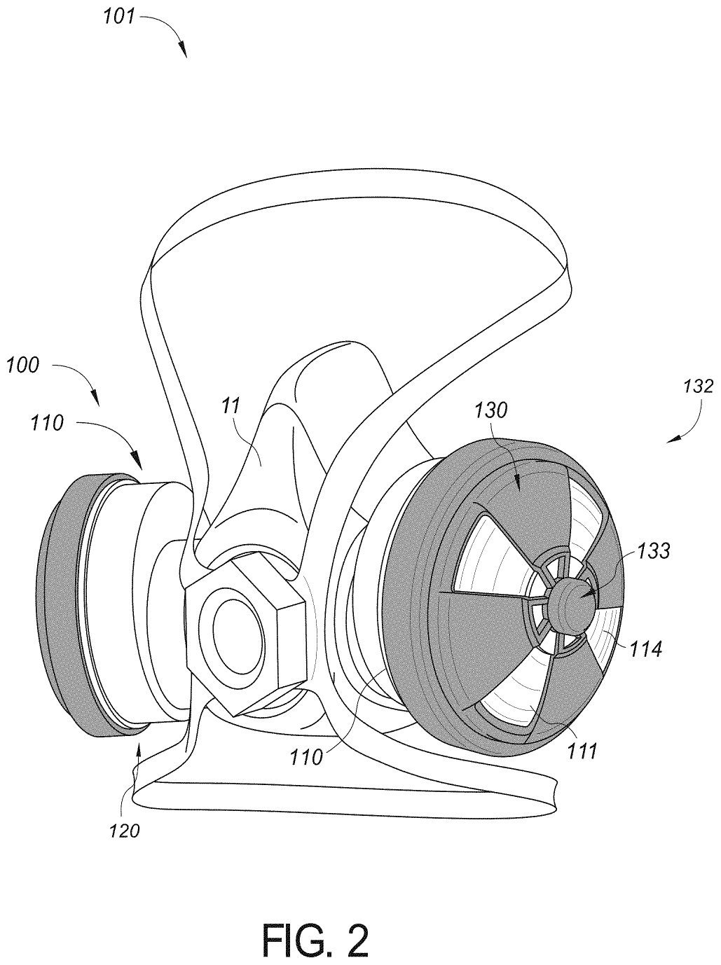

FIG. 2 is a perspective view of the particle retainer FIG. 1, mounted to a particulate matter filtration mask, according to an embodiment of the present disclosure. This illustration shows the air flow port cover 130 in a closed state 132. In particular, here, four flow ports 135 of the air flow port cover 130 are rotated closed or configured to prohibit contaminated ambient air from reaching the air filtration element 20 and to prevent particles from escaping the air filtration element.

As above, the respiration system 101 may include the particulate matter filtration mask 10, the at least one air filtration element 20 affixed to the particulate matter filtration mask 10 and be configured to filter particulate matter from contaminated ambient air entering the particulate matter filtration mask 10, and the particle retainer 100 including the support frame 110, the mask mount 120, and the air flow port cover 130.

The air flow port cover 130 may be rotatably or otherwise movably affixed to the support frame 110 (e.g., by a support post 133) and have the open state 131 (FIG. 1) and the closed state 132 (shown). In particular, when in the open state 131, the air flow port cover 130 may align with the air flow port(s) 115 (e.g., via the substrate covers 135) or otherwise permit the contaminated ambient air to pass through the air flow port(s) 115 of the support frame 110, and when in the closed state 132, as here, the air flow port cover 130 may prohibit particulate matter from passing back through the at least one air flow port 115, for example by closing or otherwise blocking the at least one air flow port 115 (e.g., moving the cover air flow port(s) 135 to a position of interference with the air flow port(s) 115).

According to one embodiment, the particle retainer 100 may also be colored or configured with materials of different/contrasting colors, such that it is readily visible whether the air flow port cover 130 is the open state 131, the closed state 132, or an intermediate state. For example, the support frame 110 may a first color 112, and the air flow port cover 130 may be a second color 113, with the first color 112 contrasting with the second color 113. Alternate embodiments are contemplated (e.g., patterns, indicia, etc.) that similarly make it easier to determine when the particle retainer 100 is currently residing in the open state 131 or the closed state 132.

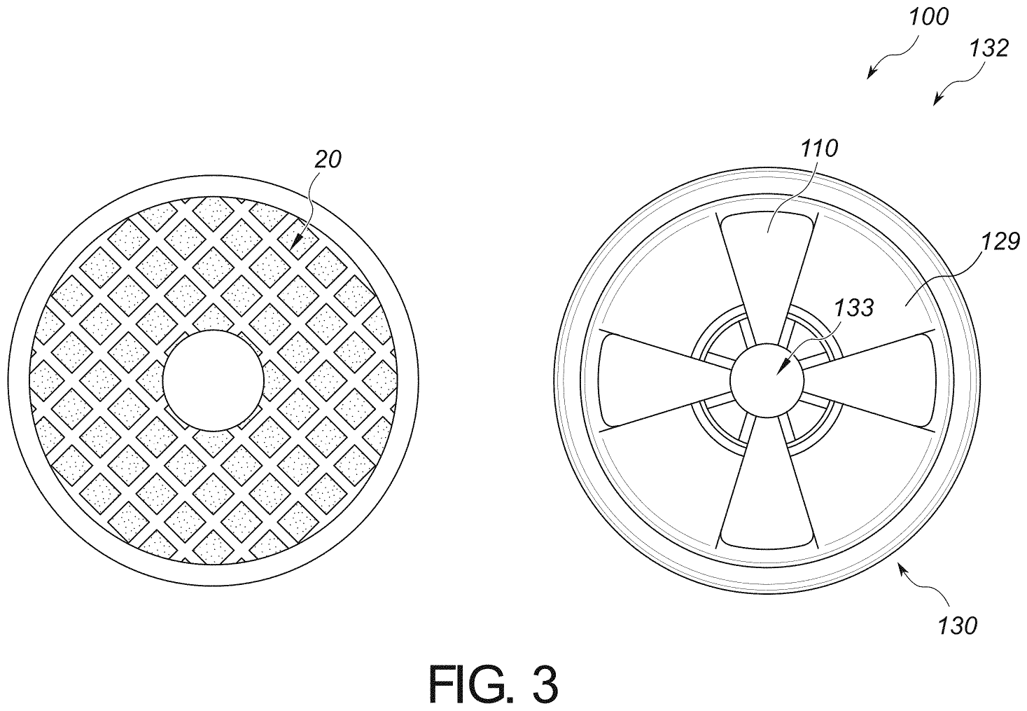

FIG. 3 is a top view of the particle retainer 100 of FIG. 1 alongside a filtration element, according to an embodiment of the present disclosure. This illustration details the particle retainer 100 placed next to one air filtration element 20, or disassembled. This illustration shows the four air flow ports 115 of the support frame 110 and the cover air flow port 135 of air flow port cover 130 in alignment or configured to permit contaminated ambient air to reach the at least one air filtration element 20 (i.e., the open state 131).

FIG. 4 is a bottom or inside perspective view of the particle retainer 100 of FIG. 1, according to an embodiment of the present disclosure. This illustration shows the open state 131 where the four air flow ports 115 and the four cover air flow ports 135 are in alignment or configured to permit contaminated ambient air to reach the at least one air filtration element 20 (FIG. 3).

As shown the mask mount 120 may be integrated with or otherwise affixed to the support frame 110. Similarly, the air flow port cover 130 may be movably affixed the support frame 110 with the support post 133, for example. Other couplings are contemplated, including slots, hinges, rings, flex joints, etc. Further, aspects of the disclosure may include embodiments where the exterior portion of the particle retainer 100 (here the air flow port cover 130) remains fixed and the interior portion of the particle retainer 100 (here the support frame 110) is rotatable or otherwise movable between the open state 131 and the closed state 132.

As above, the support frame 110 may comprise a respirator input 111 and a cover base 114 and be the first color 112, and the air flow port cover 130 may be the second color 113 in contrast. According to one embodiment the support frame 110 may be made of materials exhibiting the first color 112, and the air flow port cover 130 may be made of materials exhibiting the second color 113.

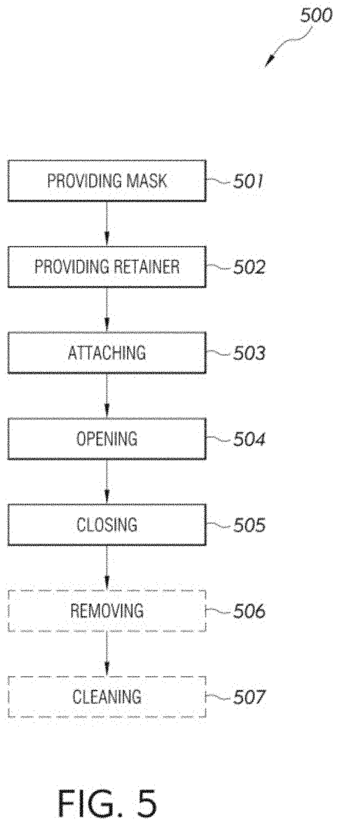

FIG. 5 is a flow diagram illustrating a method of use 500 for a respiration system 101, according to an embodiment of the present disclosure. In particular, the method for method of use 500 may include one or more components or features of the respiration system 101 as described above. As illustrated, the method of use 500 may include the steps of: step one 501, providing the particulate matter filtration mask 10, the particulate matter filtration mask 10 having at least one air filtration element 20 affixed to the particulate matter filtration mask 10 and configured to filter particulate matter from contaminated ambient air entering the particulate matter filtration mask 10; step two 502, providing the particle retainer 100 for the particulate matter filtration mask 10, the particle retainer 100 including the support frame 110, the mask mount 120, and the air flow port cover 130, the support frame 110 including at least one air flow port 115 configured to permit the contaminated ambient air to reach the at least one filtration element, the mask mount 120 fixed to the support frame 110 and configured to removably attach or be integral component of a respirator cartridge to at least one of the particulate matter filtration mask 10 and the at least one filtration element, the air flow port cover 130 affixed to the support frame 110 and having an open state 131 and a closed state 132, the open state 131 permitting the contaminated ambient air to pass through the at least one air flow port 115, and the closed state 132 prohibiting particulate matter from passing back through the at least one air flow port 115; step three 503, attaching the particle retainer 100 to the air filtration element 20; step four 504, opening the particle retainer 100; and step five 505, closing the particle retainer 100. According to one embodiment, the method 500 may further include the steps of: step six 506 removing the particle retainer from the air filtration element; and step seven 507 cleaning the particle retainer.

It should be noted that step six 506 and step seven 507 are optional steps and may not be implemented in all cases. Optional steps of method of use 500 are illustrated using dotted lines in FIG. 5 to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for a particle retainer 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A particle retainer for a filtration mask having a body, an air filtration element, and a respirator input disposed between the body and the filtration element, wherein the particle retainer comprises:
a fixed support frame having ribs extending radially from an axle mount ending at the edge of a retaining ring that extends perpendicularly away from the perimeter of the support frame toward the mask body and having fixed air-flow ports disposed between the ribs,
wherein
the ribs block airflow into the respirator input and the fixed air-flow ports allow airflow into the respirator input,
and
the retaining ring engages the respirator input;
a rotatable cover having radial leaves divided by passages and an axle that mounts in the axle mount and is rotatable around the axle between an open and a closed position,
wherein
when a user inhales and the cover is open ambient air enters into the respirator input through the fixed air-flow ports and the passages,
and
when closed the leaves seal the fixed air-flow ports and prevent hazardous particulate matter from exiting the mask.

2. The particle retainer of claim 1, wherein the fixed support frame is circular.

3. The particle retainer of claim 2, wherein the retaining ring engages the respirator input through an airtight seal.

4. The particle retainer of claim 3, wherein the retaining ring snaps into place on the respirator input.

5. The particle retainer of claim 4, wherein
the fixed support frame is a first color,
the radial leaves are a second color,
and
the relative amount of visible first color versus visible second color visually indicates whether the rotatable cover is open or closed.

6. The particle retainer of claim 5, wherein the rotatable cover is manually operable between the open and closed position.

7. The particle retainer of claim 6, wherein the rotatable cover is configured to maintain the open state or closed state.

8. The particle retainer of claim 7, wherein the axle is an one of a screw, bolt, pin, rivet, or plastic snap.

9. The particle retainer of claim 8, wherein the fixed air flow port has an area of at least 1 square centimeters.

10. The particle retainer of claim 9, wherein the particle retainer weighs less than 2 kilograms.

11. The particle retainer of claim 10, wherein the particle retainer weighs less than 1 kilogram.

12. The particle retainer of claim 11, wherein the particle retainer is made of plastic.

13. The particle retainer of claim 12, wherein the particle retainer is configured to be disposable.

14. A method comprising:
providing a particulate matter filtration mask, the particulate matter filtration mask having at least one air filtration element affixed to the particulate matter filtration mask and configured to filter particulate matter from contaminated ambient air entering the particulate matter filtration mask;
providing a particle retainer that comprises
a fixed support frame having ribs extending radially from an axle mount ending at the edge of a retaining ring that extends perpendicularly away from the perimeter of the support frame toward the mask and having fixed air-flow ports disposed between the ribs,
wherein
the ribs block airflow into the respirator input and the fixed air-flow ports allow airflow into the respirator input
and
the retaining ring is configured to engage the respirator input;
a rotatable cover having radial leaves divided by passages and an axle that mounts in the axle mount and is rotatable around the axle between an open and a closed position,
wherein
when the user inhales and the cover is open ambient air enters into the mask through the fixed air-flow ports and the passages,
and
when closed the leaves seal the fixed air-flow ports and prevent hazardous particulate matter from exiting the mask;
and
installing the particle retainer onto the mask.

15. The method of claim 14, further comprising:
opening the rotatble cover;
and
using the mask to filter hazardous particles.

16. The method of claim 15, further comprising closing the rotatable cover thereby sealing filtered hazardous particles inside the mask between the particle retainer and the air filtration element.

17. The method of claim 16, further comprising disposing of the particle retainer.
